(19) United States
(12) Patent Application Publication
(10) Pub. No.: US 2021/0187763 A1
(43) Pub. Date: Jun. 24, 2021

(54) Safety Utility Knife

(71) Applicant: Olfa Corporation, Osaka-shi, Osaka (JP)

(72) Inventor: Yosuke TAKASHIMA, Suita-shi, Osaka (JP)

(21) Appl. No.: 17/059,051

(22) PCT Filed: May 30, 2019
(86) PCT No.: PCT/JP2019/021495

§ 371 Date: Nov. 25, 2020

(30) Foreign Application Priority Data
May 31, 2018 (JP) 2018-104350

(51) Int. Cl. B26B 3/00

(52) U.S. Cl. CPC B26B 3/00; B25G 3/34

(57) ABSTRACT

A safety utility knife includes a resin-made grip part, a blade projecting from the grip part, and a resin-made head part arranged at a tip of the projecting blade. The blade is formed with a through-hole so that a resin-made coupling part lying within the through-hole couples together the grip part and the head part that are made of resin. Since the safety utility knife of the present invention allows the three resin-made parts to be joined together, it can be manufactured easily and at low cost using a 1-gate type mold. Also, there is no unnecessary increase in the blade thickness, preventing an increased cutting resistance and a rough cut end from occurring.

### TECHNICAL FIELD

The present invention relates to a safety utility knife capable of safely cutting cardboard, string material, etc.

### BACKGROUND ART

Various safety utility knives capable of safely cutting cardboard, string material, etc. have hitherto been proposed (e.g. Patent Documents 1 to 4). A safety utility knife of Patent Document 1 is shown in FIG. 1.

Blades 12a and 12b protrude from a grip part 11 held by the user to both sides, with head parts 13a and 13b being disposed at the tip of each blade for the purpose of guide and guard. The user holds the grip part 11 and draws it toward the user to cut cardboard, etc. by the blade 12a or 12b on one hand.

Typically, the blades 12a and 12b are made of metal, and the grip part 11 and the head parts 13a and 13b are each made of resin. In the case of manufacturing this, the blades are disposed on a mold and then resin making up the grip part 11 and the head parts 13a and 13b is poured into the mold. Since the grip part 11 and the head parts 13a and 13b are mutually separated (disjoined) resin molded pieces, a 3-gate type mold is required as schematically shown in FIG. 3A.

Namely, FIG. 3A shows, in a simplified manner, a safety utility knife immediately after molding using the 3-gate type mold. A runner (resin that remained in a flow path of the mold) protrudes from each of the three resin portions (11, 13a, and 13b), from which it can be understood that the 3-gate type mold was used. This runner is thereafter removed by a proper method.

Generally speaking, when using the 3-gate type mold, manufacturing labor and cost including deburring, etc. rise as compared with the case of using a 1-gate type mold that will be described later.

Patent Document 4 discloses a safety utility knife used for similar purposes, which can be manufactured using the 1-gate type mold, instead of the 3-gate type mold. That is, the safety utility knife of Patent Document 4 is an integral piece in which the grip part 11 and the head part 13a are coupled together, as shown in FIG. 2. In this utility knife, a resin part 14 coupling the grip part 11 and the head part 13a covers a blade such that only an edge 15 of the blade is exposed. According to such a configuration, the portions molded with resin are integrated, so that the 1-gate type mold can be used to consequently reduce the manufacturing labor and cost.

However, due to the resin part 14 covering and extending on the blade, another problem occurs that the cutting resistance at the time of cutting work increases. This results in problems e.g. that hand's fatigue increases because of unsmooth cutting and that a rough cut end appears.

### PATENT DOCUMENT

Patent Document 1: U.S. Design Pat. USD 784,107S
Patent Document 2: U.S. Design Pat. USD 660,675S
Patent Document 3: U.S. Design Pat. USD 802,394S
Patent Document 4: U.S. Design Pat. USD 527,604S

### SUMMARY OF THE INVENTION

### Problem to be Solved by the Invention

The present invention was devised in view of the above problems of the prior art and its object is to provide a safety utility knife capable of simplifying the manufacturing process without increasing the cutting resistance, by integral configuration of a grip part and a head part using resin, etc.

### Means for Solving Problem and Effect of the Invention

A safety utility knife of the present invention comprises “a grip part”, “a blade projecting from the grip part”, and “a head part arranged at a tip of the projecting blade”. A through-hole is formed in the blade, and a coupling part lying within the through-hole couples the grip part and the head parts together.

It is preferred that the coupling part be made of resin widely usable for molding, but aluminum, zinc, magnesium, or other metals usable for diecast molding may also be available.

In the safety utility knife of the present invention having the above configuration, the coupling part lying within the through-hole formed in the blade couples the grip part and the head parts together. Accordingly, manufacture using the 1-gate type mold becomes possible so that the mold configuration can be simplified to suppress cost, as compared with the case of using the 3-gate type mold. In addition, manufacturing time and labor including deburring immediately after molding can be saved, and cost can be reduced from this point as well.

Moreover, since the coupling part coupling the grip part and the head parts together lies within the through-hole formed in the blade, the total thickness of the blade is prevented from increasing. This results in no increase in cutting resistance when cutting cardboard and other objects, and therefore cutting work becomes smoother (as compared with the case of increased thickness caused by the coupling part covering the blade), leading to effects of less hand fatigue and of prevention of rough cut end.

Additionally, due to lying within the through-hole, that coupling part has a higher durability as compared with the case of extending along the back of the blade. That is, breakage of the coupling part arising from repeated use of the safety utility knife is hard to occur and hence it can effectively be prevented that the broken coupling part mixes in somewhere as foreign fragments.

In the safety utility knife of the present invention, both ends of a single blade (embedded in the grip part) may protrude from the grip part to both sides in opposite directions away from each other, with the head parts being disposed at the both ends, respectively. It is preferred in this case that the above through-hole be formed in the single blade and extend from the head part on one hand to the head part on the other.

By adopting such a configuration, the single blade may only be arranged within the mold in order to configure the safety utility knife having two cutting parts. Accordingly, the blade arrangement within the mold becomes simple, resulting in reduced manufacturing labor and cost.

### BRIEF DESCRIPTION OF DRAWINGS

FIG. 1 is a view explaining an example of a conventional safety utility knife.

FIG. 2 is a view explaining another example of the conventional safety utility knife.

FIG. 3A is a schematic perspective view explaining a case of manufacturing the safety utility knife by use of a 3-gate type mold.

FIG. 3B is a schematic perspective view explaining a case of manufacturing the safety utility knife by use of a 1-gate type mold.

FIG. 4A is a view showing a tip-near region of a safety utility knife according to a first embodiment of the present invention.

FIG. 4B is an opened-up view showing a blade arranged within the safety utility knife of FIG. 4A.

FIG. 5 shows perspective views of back and front shapes of the safety utility knife of the present invention.

FIG. 6 shows six different views of the safety utility knife of FIG. 5.

### EMBODIMENT(S) FOR CARRYING OUT THE INVENTION

### First Embodiment

A first embodiment of the present invention will now be described with reference to the accompanying drawings. Although details of the first embodiment are described below, a grip part 31, head parts 33a and 33b, and a coupling part 35 are made of resin and manufactured using a mold.

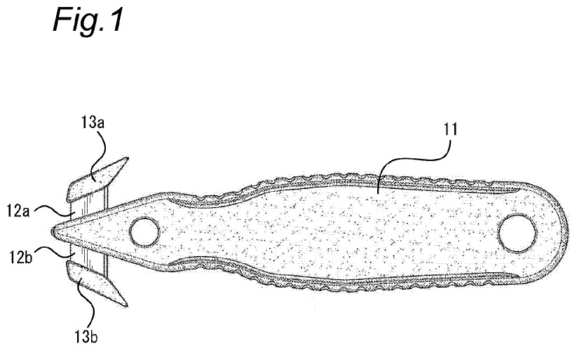

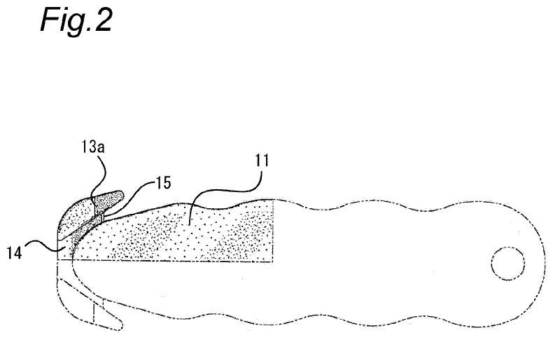

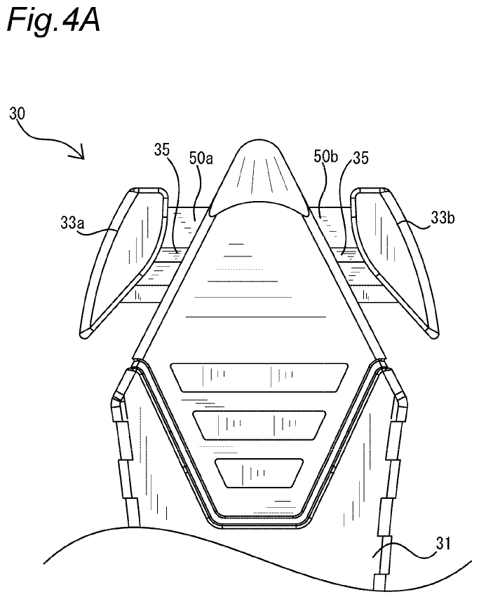

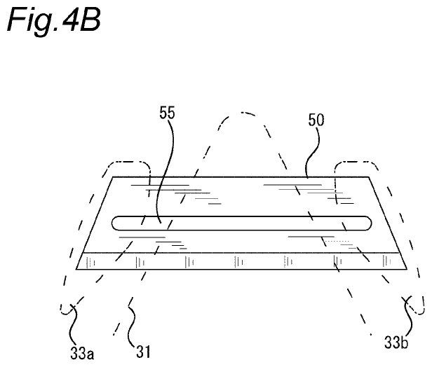

FIG. 4A shows a safety utility knife 30 according to a first embodiment of the present invention. Although only near the tip of the safety utility knife 30 is shown in FIG. 4A, the whole is elongated similar to the conventional ones shown in FIGS. 1 and 2, and the user holds the grip part 31 and draws it toward the user to cut cardboard, etc. by a blade 50a or 50b on one hand.

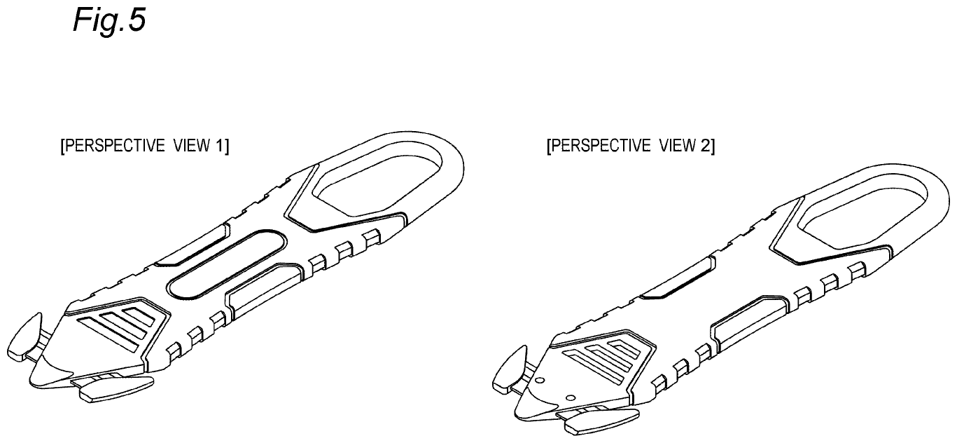

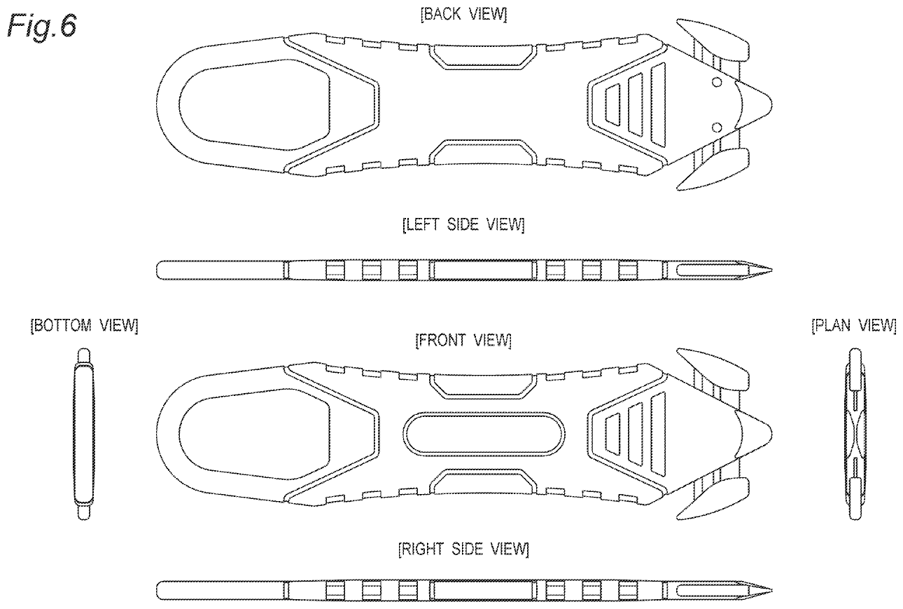

FIGS. 5 and 6 show an example of the overall shape of the safety utility knife of the present invention.

The blades 50a and 50b protrude from (a tip region of) the grip part 31 toward both sides, with the head parts 33a and 33b being disposed on tips of the blades for the purpose of guide and guard. Such a feature itself is similar to a conventional safety utility knife shown in FIG. 1.

A principal feature of the present invention lies in that a blade 50 has an elongated hole (through-hole) 55. As a result, as described hereinbelow, effects can be obtained that a safety utility knife is manufacturable using a 1-gate type mold and, additionally, that there is no increase in the blade total thickness.

### <Manufacturable Using 1-Gate Type Mold>

FIG. 4B is an opened-up view showing the blade 50 in the safety utility knife 30 of FIG. 4A. It can be seen that the elongated hole 55 formed in the blade 50 extends from the head part 33a on one hand to the head part 33b on the other.

Although the safety utility knife 30 is made by molding, the blade 50 is set in the mold at that time so that resin is poured thereinto.

For example, when allowed to flow from the gate into a cavity portion corresponding to the grip part 31 using the 1-gate type mold, resin flows through the interior of the cavity while advancing in the through-hole 55 of the blade, to finally form the head parts 33a and 33b. After completion of molding, cured resin remaining in the through-hole 55 is the coupling part 35 in FIG. 4A.

Although there exist three resin-made parts (the grip part 31 and the head parts 33a and 33b) in this manner, these three parts are integrated by the coupling part 35 similarly made of resin, and accordingly the safety utility knife 30 of the present invention can be manufactured using the 1-gate type mold.

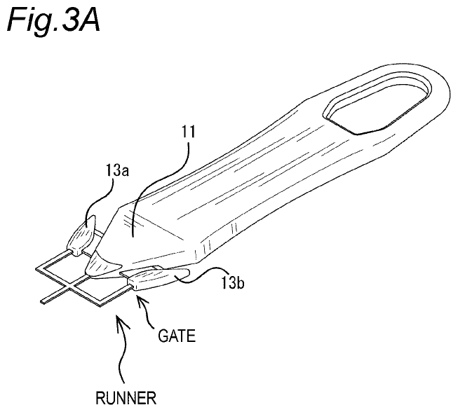

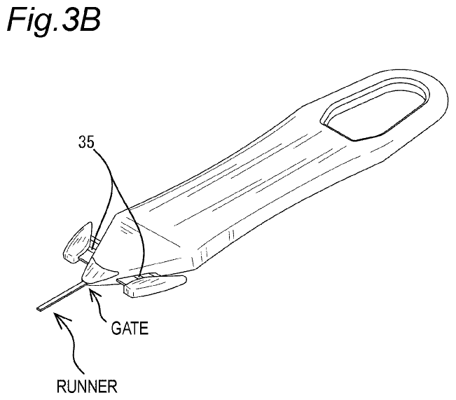

FIG. 3B explains this schematically and shows, in a simplified manner, the safety utility knife immediately after molding using the 1-gate type mold. As is apparent from comparison with FIG. 3A referred to in the description of the prior art, the runner protrudes only from one point.

Generally speaking, as compared with use of the 3-gate type mold, use of the 1-gate type mold can suppress labor and cost for manufacture including deburring. The 1-gate type mold can simplify the mold configuration for suppression of cost.

### <No Increase in Blade Total Thickness>

In addition, according to the configuration shown in FIGS. 4A and 4B, since the coupling part 35 joining the grip part 31 and the head parts 33a and 33b is enclosed in the elongated hole (through-hole) formed in the blade 50, there is no increase in thickness of the blade 50.

If the resin part 14 extends overlapping the blade as in the prior art shown in FIG. 2, the total thickness of the blade increases, which induces an increased cutting resistance or a deteriorated cut end. In the safety utility knife of the present invention, the coupling part 35 lies within the elongated hole 55 so that the blade thickness is unchanged from its original thickness (typically of the order of 0.5 to 0.6 mm), thereby preventing the increased cutting resistance or a rough cut end from occurring.

Moreover, since the coupling part 35 lies within the elongated hole 55 (in other words, since the entire circumference is surrounded by the blade 50), a higher durability is ensured as compared with the case of extending along the back of the blade 50. If the case is considered where the resin part extends outward along the back of the blade 50, repeated use of the safety utility knife allows upward forces in FIG. 4A to act on the coupling part 35 due to the friction with objects (cardboard, string material, etc.) to be cut, with the result that there is a high possibility that the coupling part 35 will break. In the present invention, since the coupling part 35 is surrounded over its entire circumference by the blade 50, such a break is hard to occur and hence it can effectively be prevented that the broken coupling part 35 mixes in somewhere as foreign fragments.

### Second Embodiment

In the first embodiment, the “grip part 31”, “head parts 33a and 33b”, and “coupling part 35” making up the safety utility knife were made of resin and manufactured using the mold.

On the contrary, in a second embodiment, the safety utility knife is manufactured by diecast molding. That is, a molten metal (aluminum, zinc, magnesium, etc.) is injected at a high pressure into a die attached to a diecast machine and is solidified. Therefore, all of the “grip part 31”, “head parts 33a and 33b”, and “coupling part 35” are made of metal.

Also in the second embodiment, similarly to the case of the first embodiment, the 1-gate type mold can be used for manufacture with no increase in the blade total thickness. Accordingly, effects similar to the case of the first embodiment described above can be obtained.

For both of the first embodiment and the second embodiment described above, variants as will be described below can each be adopted.

### Variants

(1)

In the embodiment shown in FIGS. 4A and 4B, the blades 50a and 50b project from the grip part 31 to both sides so that the safety utility knife 30 has a cutting part at two sites. The present invention is not limited to such a configuration, but, for example, the blade may project only to one side.

Also in such a case, the grip part and the head parts can be coupled together via the coupling part by providing a proper through-hole in the blade, thus enabling the 1-gate type mold to be used for manufacture.

(2)

In the embodiment shown in FIGS. 4A and 4B, a single blade 50 was embedded inside the grip 31 such that both ends 50a and 50b of the single blade each projected to the side of the grip part 31. However, the present invention is not limited to such a configuration, but two separate blades may be used to make up a safety utility knife.

Furthermore, three or more separate blades may be used to obtain a safety utility knife having three or more cutting parts. In any case, the blades are each formed with a through-hole so that the coupling part poured thereinto couples the grip part and the head parts together. Thereby, the safety utility knife can be manufactured using the 1-gate type mold.

### EXPLANATIONS OF LETTERS OR NUMERALS

11 grip part
12a, 12b blade
13a, 13b head part
14 resin part
15 edge
30 safety utility knife
31 grip part
33a, 33b head part
35 coupling part
50, 50a, 50b blade
55 elongated hole

1. A safety utility knife comprising:
a grip part;
a blade projecting from the grip part, the blade being formed with a through-hole;
a head part arranged at a tip of the projecting blade; and
a coupling part lying within the through-hole coupling the grip part and the head part together.

2. The safety utility knife according to claim 1, wherein the grip part, the head part, and the coupling part are made of resin.

3. The safety utility knife according to claim 1, wherein
both ends of a single blade project from the grip part to both sides in opposite directions away from each other so as to be the blades respectively, and
the head part is disposed at each of the both ends of the single blade, and
the through-hole is formed in the single blade and extends from the head part on one hand to the head part on the other.

4. The safety utility knife according to claim 2, wherein
both ends of a single blade project from the grip part to both sides in opposite directions away from each other so as to be the blades respectively, and
the head part is disposed at each of the both ends of the single blade, and
the through-hole is formed in the single blade and extends from the head part on one hand to the head part on the other.
